(19) United States
(12) Patent Application Publication
(10) Pub. No.: US 2019/0055408 A1
(43) Pub. Date: Feb. 21, 2019

(54) Method for the Fixation of Metals, Transition Metals and their Oxides on Siliceous Materials of Plant Origin and Use of these Modified Siliceous Materials as a Catalyst and a Loading Material for Pigments, Paints, Plastics, Elastomers and Sizing Materials

(71) Applicants: Matthias Schmidt, Dresden (DE); Frank Kose, Berlin (DE); Green Sugar AG, Meissen (DE)

(72) Inventors: Matthias Schmidt, Dresden (DE); Frank Kose, Berlin (DE)

(21) Appl. No.: 16/079,109

(22) PCT Filed: Feb. 17, 2017
(86) PCT No.: PCT/DE2017/000032

§ 371 Date: Aug. 23, 2018

(30) Foreign Application Priority Data
Feb. 24, 2016 (DE) 10 2016 002 091.1
Jan. 10, 2017 (DE) 10 2017 000 114.6

(51) Int. Cl. C09C 1/30; B01J 21/06; B01J 37/06; B01J 37/08; B01J 37/02

(52) U.S. Cl. CPC C09C 1/3045; B01J 21/06; B01J 37/0207; B01J 37/082; B01J 37/06

(57) ABSTRACT

The invention relates to a method, in which siliceous biomass is modified in the spectrum of the existing non-silicon metals and these non-silicon metals are fixed onto the siliceous skeleton of the plant by burning. The ashes produced can be used as auxiliary agents for heterogeneous catalysis in the chemical industry and as loading materials for plastics, elastomers, pigments, paints and sizing materials.

### CROSS REFERENCE TO RELATED APPLICATIONS

This application is the U.S. national stage of International Application No. PCT/DE2017/000032, filed on 2017 Feb. 17. The international application claims the priority of DE 102016002091.1 filed on 2016 Feb. 24 and the priority of DE 102017000114.6 filed on 2017 Feb. 10; all applications are incorporated by reference herein in their entirety.

### BACKGROUND

### State of the Art

In the patent application with the file number DE 10 2016 002 091.1, which is hereby claimed together with its priority, it was disclosed how any metals may be fixed on a siliceous support of plant origin.

The method comprises the following method steps:
1. Washing of a silicate-containing biomass using a washing solution which contains an acid, preferably a hydrohalic acid, preferably hydrochloric acid. Non-silicon metals (this means all metals apart from silicon) are thus passed into the washing solution.
2. The washing solution is removed with the aid of any process and hence also all dissolved non-silicon metals which were passed into the washing solution in step 1. Organic material is still present in the washing residue.
3. The washing residue is soaked or treated with a liquid which contains a metal (for example in dissolved form as an ion). The organic structure in the washing residue ensures uniform distribution of the liquid along the plant structures.
4. Combustion of the soaked biomass and fixing of the existing metals on the siliceous skeleton of the plant which remains as ash on which the existing metals have been fixed.

Drying also conventionally takes place between the 3rd and 4th step. However, this does not change the core of the invention. Siliceous ashes, on which the metals present in the liquid (step 3) are fixed, result as the product. Silicate-containing biomass means all biomasses which contain more than 0.5% of silicates (relative to the dry mass of the biomass used).

This invention should be broadened to the effect that the procedure and limiting conditions of the method should be outlined in detail.

Furthermore, it has been disclosed in patent DE 10 2014 014 177.3 that silicates or siliceous materials of plant origin are suitable as a loading material for pigments, paints, plastics, elastomers and sizing materials. The application of these silicates should herewith be broadened to the effect that silicates or siliceous materials of plant origin, on which metals have been fixed, are colored and their color may be determined by choosing the metals which have been fixed on the silicates or siliceous materials of plant origin. It is thus possible to link the positive properties of these silicates (for example increasing the scratch resistance) with structural aspects (for example important for pigments and paints).

### SUMMARY

Generally it is possible using the method to fix several metals. This results from the fact that the mechanism is valid for the fixation of any metals and, after washing, the biomass may thus also be soaked with solutions which contains a mixture of different metals. This should be mentioned here once again and explicitly claimed. It has been shown that transition metals may also be fixed with the aid of the method explained. Application of the method to transition metals and mixtures of transition metals and metals should herewith likewise be claimed. Furthermore, when mentioning the metals and/or transition metals, their oxides should always also be included and be claimed.

### DETAILED DESCRIPTION

The basic principle of the invention corresponding to the patent with the file number DE 10 2016 002 091.1, as has been disclosed in the section “State of the art”, remains untouched.

However, it has been shown that the washing and removing of the non-silicon metals (all metals apart from silicon) does not have to be carried out in every case. What is important for the mode of operation of the method are two limiting conditions.
1. Soaking of the plant biomass with a solution, which contains the metal and/or the metals and/or the transition metal and/or the transition metals and/or their mixtures (also possible in ionic form or as dissolved salt) and which penetrates into the biomass, is effected. The plant, non-siliceous material (for example the (hemi)cellulose skeleton or the lignin) thus acts as a sponge. The solution is uniformly distributed in the entire biomass due to this “sponge” effect. Hence, there is positioning of the metal and/or the metals and/or the transition metal and/or the transition metals and/or their mixtures on all accessible surfaces of the siliceous skeleton present in the plant. The metals and/or transition metals present in the solution are thus fixed in the process of combustion uniformly on the siliceous skeleton of the plant biomass remaining after combustion. This is advantageous, for example for the use of the resulting combustion product as a catalyst, since heterogeneous catalysis is always carried out on the surface of the catalyst and the surface area which can be used for catalysis is maximized by the uniform distribution of the (transition) metal-containing solution in the entire biomass. In addition, plant-based silicates or siliceous materials of plant origin are greatly fissured or porous, since these silicates are incorporated into the cell skeleton of the plant in the production process (when the plant grows and lives) and reproduce the latter. (After combustion, for example fissure openings can be seen clearly). Hence, silicates of plant origin are particularly suitable for heterogeneous catalysis if it is possible to introduce the metals necessary therefor to a maximum extent and to distribute them uniformly. Soaking may also be effected in the gaseous phase if it is possible either to fix the metal by means of chemical bonding to a substance which may be evaporated or to evaporate the metal itself.
2. Care must be taken to ensure that during combustion there is no formation of melts. The resulting slag is no longer suitable as a catalyst or a loading material. This is particularly important when the non-silicon metals have not been removed by preceding washing, since these metals lower the melting point of the siliceous material. Prevention of the production of melts is possible in that the combustion is carried out at lower temperatures so that no melts are produced. On the other hand, care should be taken to ensure that during combustion, so-called coke burn-off takes place. If this is not effected, coke remains in the combustion residue. The material thus produced would not be suitable. The combustion temperature may be increased by controlled heating (for example electrical, by gas combustion, flue gases) and lowered by increasing the quantity of air supplied (this acts for example in a cooling manner if the air has not been pre-heated). It is thus important that there is no falling below the ignition temperature of the coke. The latter lies at about 200 to 280° C. This temperature range forms the lower limit of the combustion temperature. The upper limit cannot be clearly defined, since it depends on which non-silicon metals in which proportion are present in the biomass.

### DETAILED DESCRIPTION OF THE PREFERRED EMBODIMENTS

Therefore a determination method (determination method 1) should be described here, with the aid of which the lower and the upper limit for carrying out the combustion may be determined. The method comprises the following steps.

Step 1: The biomass is soaked in a required (transition) metal-containing solution (this contains all required metals, transition metals and their mixtures), and the latter is taken as the base material for determining the temperature range in which combustion may be carried out successfully (coke burn-off complete, no slag formation). Pre-drying is possible before combustion.

Step 2: The lower limit of the combustion temperature is designated by the variable T(bottom) and postulated with a value of 200° C.

Step 3: The soaked material (corresponding to step 1) is com busted at the temperature corresponding to T(bottom). If coke burn-off is complete, the lower limit for the combustion temperature is thus determined and is fixed here by the value corresponding to T(bottom), independently of the use of the variable T(bottom) as an auxiliary variable in step 5. On complete coke burn-off, the process continues with step 4. If coke burn-off is not successful, T(bottom) is increased by 1° C. and step 2 repeated.

Step 4: The upper limit of the combustion temperature is designated by the variable T(top) and postulated with a value of 2000° C.

Step 5: The soaked material is combusted at the temperature corresponding to T(top). If slag is thus produced, T(top) is re-calculated. T(top) results (for slag formation) from the average of T(top) and T(bottom). If no slag is thus produced, T(bottom) and T(top) are increased by the differential amount between T(top) and

T(bottom) and then T(top) is re-determined and defined by determining the average value of T(bottom) and T(top). Step 5 is continued until the temperatures T(top) and T(bottom) differ by less than 0.01° C.

The upper limit for the combustion temperature is fixed by the value corresponding to T(top), as results from step 5.

This determination method may be applied independently of whether washing for removing unwanted non-silicon metals was effected.

In practice it may happen that coke burn-off takes place only when formation of slag has already started. In this case washing using an acid (or another material which is able to convert non-silicon metals into their soluble form) and conversion of the non-silicon metals into their soluble form and their removal is inevitable.

The complete removal of all non-silicon metals by means of washing and removal of the washing solution is desirable, but difficult to achieve in practice and not always necessary for the most part for application of the product. It has been shown that even purities (purity corresponds here to mass proportion of silicon relative to the mass of all metals) of >50% were sufficient to generate useable products (here for admixture in pigments and paints). This value which appears low must be illustrated to the effect that the metals which are added with soaking of the biomass, likewise are non-silicon metals and in principle may lead to the formation of melts (here the method for determining the temperature bottom and top limits may again be applied). Whereas thus non-silicon metals are removed during washing (including removal of the washing solution), they are supplied again by means of soaking. The innovation consists in that the spectrum of the existing non-silicon metals may be adjusted in a defined manner by means of washing (including removal of the washing solution) and soaking. Hence, in addition to the metals, also transition metals, which should be claimed herewith, are also suitable. They (for example uranium) may have a high molecular weight and let the purity value thus appear low.

As washing solution, in principle all materials may be used which make it possible to convert the non-silicon metals in the biomass into their soluble form. The term “solution” may be broadened, for example also to the effect that gaseous materials are suitable to convert non-silicon metals to their soluble form. Hence, it is possible, for example to treat moist biomass by means of gaseous hydrogen chloride. The hydrogen chloride absorbs in the moist biomass and forms hydrochloric acid there, which in turn converts existing metals and their oxides into the corresponding chlorides and thus renders them soluble. The washing solution thus generated in the biomass may be removed by means of displacement through distilled water. The following steps may be carried out as described.

In addition to the preferred hydrochloric acid, in principle all other acids are also suitable to convert non-silicon metals into their soluble form. Restrictions result from the fact that some acids form insoluble salts with different metals, hence sulfuric acid with calcium forms calcium sulfate (gypsum). However, it may also result here that calcium is present only to a very low extent in the biomass and it is possible for a user to utilize good-value sulfuric acid (for example as a waste stream in a different process), hence to carry out economically useful washing by means of sulfuric acid, in particular when washing is effected at higher temperatures (for example than boiling and/or under pressure). Then acids may also be used in lower concentration.

Removal of the washing acid is preferably effected by means of displacement through distilled water. However, any other substance is also conceivable. It is fundamental only that the previously dissolved non-silicon metals are removed from the biomass and are not present in the substance which is used for the displacement.

The essence of the method thus consists in defining the spectrum of non-silicon metals existing in the silicate-containing biomass according to the required claims, fixing these existing metals on the silicate skeleton by means of combustion and during combustion taking care to ensure that on the one hand coke burn-off is effected completely and on the other hand no melts are produced (determination method 1 may thus be used). The spectrum of non-silicon metals is defined in that the unwanted non-silicon metals present in the biomass are converted by means of washing (preferably with acid, preferably with hydrochloric acid) into their soluble form and the washing solution used for washing is removed (preferably by displacement with distilled water). The biomass thus freed of unwanted non-silicon metals may optionally be dried and is then soaked with a solution in which the required non-silicon metals are present. This pre-treated biomass may optionally be dried and is then fed to combustion.

The concentration of the acid used is not relevant, since a reduced ability to convert the unwanted non-silicon metals into their soluble form may be compensated by an increased quantity of washing acid and by temperature increase during washing.

Combustion may be carried out in ovens of any form. Combustion is preferably in a rotary kiln or fluidized-bed combustion.

Depending on how the combustion is controlled (for example by variation of the supply of combustion air and/or oxygen) or the combustion temperature is regulated, the metals are fixed in a different manner. Under rather oxidizing conditions, the metals are fixed as metal oxides on the siliceous support. Under less oxidizing or reducing conditions, the metals are fixed in elemental form on the siliceous support. It is likewise possible to apply other metal compounds, such as for example carbides, to the silicates.

The thus fixed metals may be changed as regards their oxidation state after combustion using reducing agents or oxidizing agents.

The thus fixed metals may be used in unity with the support material in the chemical industry as catalytic auxiliaries for the catalysis of chemical reactions (heterogeneous catalysis). Fixing of the catalytically effective metals is thus not lost.

In addition to the use as a catalyst, the resulting ashes may also be used as a loading material for pigments, paints, plastics, elastomers and sizing materials. An effect is given according to patent application 10 2014 014 177.3 (claimed there for silicates on which no metals have been fixed actively, that is, by soaking the biomass with a metal-containing and/or transition metal-containing solution) even at a dose of 1 mg/kg. The innovation results here from the fact that the resulting ashes, depending on which metal, transition metal or mixture of several metals and/or transition metals has or have been fixed thereon, have different colors. This colored nature may be specifically utilized and combined with the positive properties of the silicates.

1. A method for the fixation of metals, transition metals and their oxides on a siliceous support material of plant origin, characterized in that:
a. silicate-containing biomass is used, wherein the latter contains more than 0.5% of silicates (relative to the dry mass of the biomass used),
b. the spectrum of the non-silicon metals present in the biomass (this means all metals apart from silicon) is defined in that in a first washing step, all unwanted non-silicon metals present in the biomass are dissolved by means of the washing solution used and the washing solution is removed and in that in a second step, the biomass is treated with a substance or is soaked in the latter which contains the required metals and/or transition metals and/or their oxides or their mixtures,
c. the metals and/or transition metals and/or their oxides or their mixtures present in the biomass are fixed in a combustion step on the siliceous skeleton of the plant, which remains at the end of combustion as ash, on which the existing metals and/or transition metals and/or their oxides or their mixtures have been fixed,
d. pre-drying of the biomass may optionally be carried out before combustion.

2. The method as claimed in claim 1, characterized in that the steps for removing existing non-silicon metals by means of washing in a washing solution, which dissolves existing non-silicon metals, and removing the washing solution, are omitted.

3. The method as claimed in claim 1, characterized in that the temperature in the combustion is controlled so that:
a. no melts are produced and
b. that coke burn-off is effected completely.

4. The method as claimed in claim 3, in which the admissible temperature range for combustion is determined in a series of test experiments as follows:
a. Step 1: The biomass is soaked in a solution which contains only the required metals and/or transition metals and/or their oxides or their mixtures, and the latter is taken as the base material for determining the temperature range in which combustion may be carried out successfully, the success is characterized in that coke burn-off is effected completely and no melts or slag are produced.
b. Step 2: The lower limit of the combustion temperature is designated by the variable T(bottom) and postulated with a value of 200° C.
c. Step 3: The soaked material (corresponding to step 1) is com busted at the temperature corresponding to T(bottom). If coke burn-off is complete, the lower limit for the combustion temperature is thus determined and is fixed here by the value corresponding to T(bottom), independently of the use of the variable T(bottom) as an auxiliary variable in step 5. On complete coke burn-off, the process continues with step 4. If coke burn-off is not complete, T(bottom) is increased by 1° C. and step 2 repeated.
d. Step 4: The upper limit of the combustion temperature is designated by the variable T(top) and postulated with a value of 2000° C.
e. Step 5: The soaked material is combusted at the temperature corresponding to T(top). If slag or melts are thus produced, T(top) is re-calculated. T(top) results (for slag formation or melt formation) from the average of T(top) and T(bottom). If no slag or melts are produced during combustion, T(bottom) and T(top) are increased by the differential amount between T(top) and T(bottom) and then T(top) is re-determined and defined by determining the average value of T(bottom) and T(top). Step 5 is continued until the temperatures T(top) and T(bottom) differ by less than 0.01° C.
f. The upper limit for the combustion temperature is fixed by the value corresponding to T(top), as results from step 5.

5. The method as claimed in claim 1, characterized in that the washing solution contains hydrochloric acid in any concentration.

6. The method as claimed in claim 1, in which the combustion is controlled under oxidative and/or reductive conditions and hence the oxidation state of the fixed metals may be varied.

7. The method as claimed in claim 1, characterized in that the siliceous ashes after combustion with the aid of oxidizing agents or reducing agents are treated in oxidative or reductive manner and the fixed metals are changed as regards their oxidation state.

8. A heterogeneous catalytic method, in which chemical reactions are catalyzed on the metals or transition metals which have been fixed on silicates of plant origin by means of the method as claimed in claim 1.

9. The use of ashes which have been produced by means of the method as claimed in claim 1, as a loading material for plastics, elastomers, pigments, paints and sizing materials.

10. The use of ashes as claimed in claim 9 as a loading material for plastics, elastomers, pigments, paints and sizing materials, characterized in that the ashes are admixed in a dose of >1 mg/kg.
